(19) United States
(12) Patent Application Publication
(10) Pub. No.: US 2017/0062851 A1
(43) Pub. Date: Mar. 2, 2017

(54) FUEL CELL STACK END CELLS WITH IMPROVED DIAGNOSTIC CAPABILITIES

(71) Applicant: GM GLOBAL TECHNOLOGY OPERATIONS LLC, DETROIT, MI (US)

(72) Inventors: MARK F. MATHIAS, ROCHESTER HILLS, MI (US); JINGXIN ZHANG, NOVI, MI (US); BALASUBRAMANIAN LAKSHMANAN, ROCHESTER HILLS, MI (US); MANISH SINHA, ROCHESTER HILLS, MI (US)

(21) Appl. No.: 14/695,734

(22) Filed: Apr. 24, 2015

(51) Int. Cl. H01M 8/04291; H01M 8/04492; H01M 8/241; B60L 11/18; H01M 4/92; H01M 8/2457; H01M 8/0258; H01M 8/10; H01M 8/04089; H01M 4/90

(52) U.S. Cl. CPC H01M 8/04291; H01M 8/04104; H01M 8/04529; H01M 8/241; H01M 4/9025; H01M 4/92; H01M 8/2457; H01M 8/0258; H01M 8/10; B60L 11/1881; H01M 2004/8684

(57) ABSTRACT

Systems and methods are disclosed that provide for a fuel cell stack assembly including stack end cells that facilitate improved diagnostic and detection capabilities. In certain embodiments, an anode side of a FC stack end cell consistent with embodiments disclosed herein may be configured to have a lower anode gas flow rate than other cells in the FC stack. The cathode side of a FC stack end cell consistent with embodiments disclosed herein may be further configured to have a higher gas flow rate than other cells in the FC stack. Embodiments of the disclosed FC stack end cells may, among other things, allow for detection of adverse conditions and/or events in a FC stack assembly prior to such conditions and/or events negatively affecting other cells in the FC stack.

### TECHNICAL FIELD

This disclosure relates to fuel cell systems. More specifically, but not exclusively, this disclosure relates to a fuel cell stack assembly including stack end cells that facilitate improved diagnostic and detection capabilities.

### BACKGROUND

Passenger vehicles may include fuel cell (“FC”) systems to power certain features of a vehicle's electrical and drivetrain systems. For example, a FC system may be utilized in a vehicle to power electric drivetrain components of the vehicle directly (e.g., electric drive motors and the like) and/or via an intermediate battery system. A FC system may include a single cell or, alternatively, may include multiple cells arranged in a stack configuration.

In a FC system that includes a FC stack comprising tens to hundreds of individual cells, under normal operating conditions, the various cells of the FC stack may have similar cell voltages. Individual cells, however, may behave differently due to cell-to-cell variation under certain operating conditions (e.g., extended low power conditions, high relative humidity and low temperature conditions, higher temperature low relative humidity conditions, startup conditions, shutdown conditions, and/or the like). Such behavior may cause cell voltage deviation from nominal voltage levels resulting in, among other things, damage to cell components and/or compromised FC stack durability and/or longevity.

### SUMMARY

Embodiments of the systems and methods disclosed herein provide for a FC stack assembly that includes one or more stack end cells and/or sets of stack end cells with improved diagnostic and detection capabilities. In certain embodiments, an anode side of a FC stack end cell consistent with embodiments disclosed herein may be configured to have a lower anode gas flow rate than other cells in the FC stack (e.g., 5% lower or the like). The cathode side of a FC stack end cell consistent with embodiments disclosed herein may be further configured to have a higher cathode gas flow rate than other cells in the FC stack (e.g., 5% higher or the like). Embodiments of the disclosed FC stack end cells may, among other things, allow for detection of adverse conditions and/or events in a FC stack assembly prior to such conditions and/or events negatively affecting other cells in the FC stack. In certain embodiments, stack end cells consistent with embodiments disclosed herein may be enhanced with features that improve their robustness relative to other cells in the stack, thus ensuring that the end cells may sustain their diagnostic capability over the life of the stack.

In some embodiments, a FC system may include a plurality of fuel cells configured in a stack assembly. A first end cell (or a set of first end cells) may be disposed at a first end of the fuel cell stack assembly, and a second end cell (or a set of second end cells) may be disposed at a second end of the fuel stack assembly. The first end cell and the second end cell may each comprise an anode side having a lower anode gas flow relative to the other fuel cells of the fuel cell stack assembly and a cathode side having a higher cathode gas flow relative to the other fuel cells of the fuel cell stack assembly.

In certain embodiments, the anode sides of the end cells may comprise anode side flow channels that are shallower relative to anode side flow channels of other cells in the stack assembly. In further embodiments, the anode sides of the end cells may comprise diffusion media layers that are configured to intrude into the anode side flow channels more than diffusion media layers associated with other cells. The anode sides may further comprise partially-restricted anode flow fields (e.g., incorporating partially-blocked anode flow tunnels and/or the like). In some embodiments, the anode sides may comprise an anode material (e.g., IrOx or the like) having a higher amount of oxygen evolution reaction catalyst, a higher amount of hydrogen oxidation catalyst, no catalyst support, and/or a more corrosion resistant catalyst support relative to anodes included in the plurality of fuel cells.

In further embodiments, the cathode sides of the end cells may comprise cathode side flow channels that are deeper relative to cathode side flow channels of other cells in the stack assembly. In certain embodiments, the cathode sides of the end cells may comprise diffusion media layers that are configured to intrude into the cathode side flow channels less than diffusion media layers associated with other cells. In other embodiments, to improve cell robustness, the cathode sides of the end cells may comprise a cathode material having a relatively lower ionomer-to-carbon ratio and/or higher platinum loading and/or comprising graphitized carbon and/or platinum black.

In other embodiments, a method of assembling components of a fuel cell stack may comprise disposing a plurality of fuel cells in a stack configuration, disposing a first end cell or set of end cells at a first end of the stack configuration, and disposing a second end cell or set of end cells at a second end of the stack configuration. Consistent with embodiments disclosed herein, the first end cell(s) and the second end cell(s) may each comprise an anode side having a lower anode gas flow relative to the other fuel cells of the fuel cell stack assembly and a cathode side having a higher cathode gas flow relative to the other fuel cells of the fuel cell stack assembly.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates a perspective view of a portion of a FC stack end cell consistent with embodiments disclosed herein.

FIG. 2 illustrates a diagram of a FC stack assembly including FC stack end cells consistent with embodiments disclosed herein.

FIG. 3 illustrates a flow chart of an exemplary method of assembling a FC stack consistent with embodiments disclosed herein.

### DETAILED DESCRIPTION

A detailed description of systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure will be best understood by reference to the drawings, wherein like parts may be designated by like numerals. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

Embodiments of the systems and methods disclosed herein provide for a FC stack assembly comprising stack end cells that allow for improved diagnostic and detection capabilities. Certain embodiments may be utilized in conjunction with a PEMFC system, although other types of FC systems may also be utilized. In a PEMFC system, hydrogen may be supplied to an anode of the FC, and air (or oxygen) may be supplied as an oxidant to a cathode of the FC. A PEMFC may include a membrane electrode assembly (“MEA”) including a proton but not electron conductive solid polymer electrolyte membrane having an anode-catalyst-containing layer on one of its faces and a cathode-catalyst-containing layer on the opposite face. The membrane with the adjoining catalyst layers may be sandwiched between anode and cathode gas diffusion layers (“GDL”) to form the MEA. The MEA may be disposed between a pair of electrically conductive elements forming portions of a bipolar plate and serving as current collectors for the anode and cathode. The bipolar plates may define one or more flow channels for distributing the gaseous reactants over the surfaces of the respective anode and cathode catalyst layers.

A FC system may include a single cell or, alternatively, may include multiple cells arranged in a stack configuration. For example, in certain embodiments, multiple cells may be arranged in series to form a FC stack assembly. In a FC stack assembly, a plurality of cells may be stacked together in electrical series and be separated by gas impermeable, electrically conductive bipolar plates. The bipolar plate may perform a variety of functions and be configured in a variety of ways. In certain embodiments, the bipolar plate may define one or more internal cooling passages and/or channels including one or more heat exchange surfaces through which a coolant may flow to remove heat from the FC stack generated during its operation.

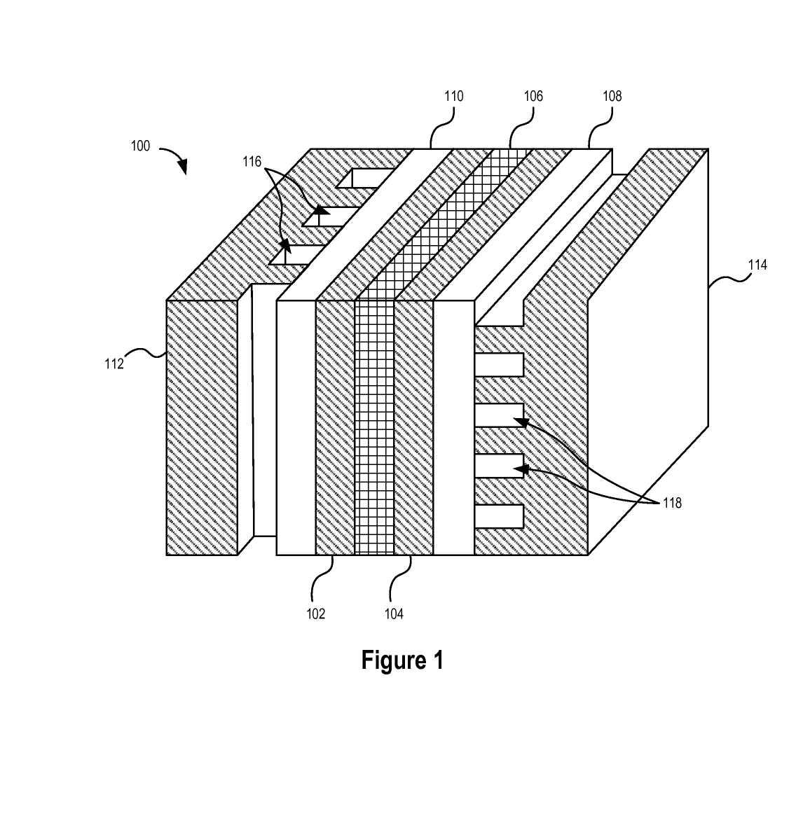

FIG. 1 illustrates a portion of a FC stack end cell 100 of a FC stack assembly consistent with embodiments disclosed herein. The FC stack assembly may, among other things, be a FC stack assembly of a FC system included in a vehicle. The vehicle may be a motor vehicle, a marine vehicle, an aircraft, and/or any other type of vehicle, and may include any suitable type of drivetrain and/or stationary power supply for incorporating the systems and methods disclosed herein. The FC system may be configured to provide electrical power to certain components of the vehicle and/or other electrically powered device collectively described herein as FC powered equipment (“FCPE”). For example, the FC system may be configured to provide power to electric drivetrain components of the vehicle. The FC stack assembly may include a multiple cells arranged in a stack configuration, and may include certain FC system elements and/or features described above.

The FC stack end cell 100 may comprise a cathode 104 and an anode 102 separated by a proton exchange membrane (“PEM”) 106. The cathode may comprise a cathode-side catalyst layer disposed against a first side of the PEM 106 and a cathode-side microporous layer disposed against the cathode side catalyst layer. A cathode-side gas diffusion layer 108, including the cathode-side microporous layer, may be disposed against the cathode 104. The anode 102 of the FC may comprise an anode-side catalyst layer disposed against a second side of the PEM 106 and an anode-side microporous layer disposed against the anode side catalyst layer. An anode-side gas diffusion layer 110, including the anode-side microporous layer, may be disposed against the anode 102. FCs of the FC stack may be stacked together in electrical series and be separated by gas impermeable electrically conductive plates. The plates may comprise a plurality of conductive sheets. For example, a first plate may comprise sheet 112 and a second plate may comprise sheet 114. In certain configurations, such as, for example, a FC stack end cell 100, at least one plate of the FC stack end cell 100 may comprise a single sheet.

In certain embodiments, the sheets of the electrically conductive plates may be manufactured in a variety of ways including, machining, molding, stamping, and/or the like. The sheets may be affixed together through a welding and/or any other bonding process (e.g., at certain interface locations) to form the electrically conductive plates. The conductive plates and/or the constituent sheets 112, 114 may comprise any suitable material including, for example, steel, stainless steel, titanium, aluminum, carbon, graphite and/or the like. In further embodiments, the conductive plates and/or the constituent sheets 112, 114 may comprise a material that includes a conductive protective coating configured to, among other things, decrease contact resistance and mitigate degradation of the bipolar plates and/or the constituent sheets 112, 114 during operation of an associated FC system.

In certain embodiments, a cathode side of a first electrically conductive plate may be defined by sheet 114. Similarly, an anode side of a second electrically conductive plate may be defined by sheet 112. Sheet 112 may define a plurality of anode side flow channels 116. Sheet 114 may define a plurality of cathode side flow channels 118. Cathode reactant (e.g., oxygen and/or air) may flow through the cathode flow channels 118 and anode reactant (e.g., hydrogen) may flow through the anode flow channels 116. The cathode reactant (e.g., oxygen and/or air) may diffuse through the cathode side gas diffusion layer 108 and react within the cathode catalyst layer 104. The anode reactant (e.g., hydrogen) may diffuse through the anode side gas diffusion layer 110 and react within the anode catalyst layer 102. Hydrogen ions may propagate through the PEM 106, thereby creating an electric current. Although not shown, the sheets 112, 114 may further define a plurality of cooling fluid flow channels for facilitating flow of coolant during operation of the FC stack.

Consistent with embodiments disclosed herein, the FC stack end cell 100 may be configured to provide for improved diagnostic and detection capabilities. In certain embodiments, an anode side of the FC stack end cell 100 (i.e., comprising sheet 112, anode side gas diffusion layer 110, and/or anode 102) may be configured to have a lower anode gas flow rate than other cells in the FC stack (i.e., non-end cells). For example, in some embodiments, the anode gas flow rate may be at least 5% lower, although other relative pressure drops are also contemplated. The cathode side of a FC stack end cell 100 (i.e., comprising sheet 114, cathode side diffusion media layer 108, and/or cathode 104) may be configured to have a higher cathode gas flow than other cells in the FC stack (i.e., non-end cells). For example, in some embodiments, the cathode gas flow rate may be approximately at least 5% higher, although other relative cathode flow rates are also contemplated. Embodiments of the disclosed FC stack ends cells 100 may, among other things, allow for detection of adverse conditions and/or events in a FC stack assembly prior to such conditions and/or events negatively affecting other cells in the FC stack.

In certain embodiments, an anode side of the FC stack end cell 100 may be configured in a variety of ways to achieve a lower anode gas flow than other cells in the FC stack. For example, in some embodiments, the sheet 112 of the electrically conductive plate included in the anode side may define anode side flow channels 116 that are shallow relative to anode side flow channels associated with other cells in the FC stack. In further embodiments, the anode side diffusion media layer 110 may be softer and/or be otherwise designed to more readily intrude into the anode side flow channels 116 relative to diffusion media layers associated with other cells in the FC stack. In some embodiments, lower gas flow rate of the anode may be achieved by restricting an associated flow field. For example, the anode side may be configured to include one or more partially-blocked anode passageways in the anode tunnels and/or on the active-area flow field between inlet and outlet hydrogen manifolds.

In order to improve end cell robustness, a lower anode gas flow rate in an anode side of a FC stack end cell 100 consistent with embodiments herein may further be combined with an anode-catalyst layer 102 that comprises a higher amount of oxygen evolution reaction catalyst relative to the anodes of other cells in the FC stack. For example, in certain embodiments, the anode 102 of the FC stack end cell 100 may comprise 4-8 times higher oxygen evolution reaction catalyst than the anodes of other cells in the FC stack. In some embodiments, a high IrOx loading anode may be utilized in connection with a FC stack end cell 100. In further embodiments, platinum black may be utilized as an anode catalyst (e.g., instead of platinum nanoparticles supported on carbon). In some embodiments, the anode 102 of the FC stack end cell 100 may comprise more corrosion-resistant catalyst support such as graphitized carbon, carbon nanofiber/nanotube, metal oxide support such as TiOx, SnOx, and/or the above oxides further doped with W, In, Sb, and/or the like.

In some embodiments, a cathode side of the FC stack end cell 100 may be configured in a variety of ways to achieve a relatively higher flow than other cells in the FC stack. For example, in some embodiments, the sheet 114 of the electrically conductive plate included in the cathode side may comprise cathode flow channels 118 that are deeper relative to cathode side flow channels associated with other cells in the FC stack. In further embodiments, the cathode side gas diffusion layer 108 may be thinner and/or be otherwise designed to exhibit less intrusion into the cathode side flow channels 118 relative to gas diffusion layers associated with other cells in the FC stack (e.g., the cathode side gas diffusion layer 108 may be relatively stiffer). In yet further embodiments, the cathode 104 of the FC stack end cells 100 may have a lower ionomer-to-carbon ratio than other cells in the FC stack.

Various exemplary features for improving diagnostic and detection capabilities of a FC stack end cell 100 as well as features for improving FC stack end cell robustness, including many of the features discussed above, are detailed below in Table 1:

TABLE 1

| | Exemplary Cell Diagnostic and | | Exemplary Cell | |
|---|---|---|---|---|
| | Detection Features | | Robustness Features | |
| | Cell Feature | Example | Cell Feature | Example |
| Anode | Higher anode | Shallower flow field | Higher | Higher Pt loading |
| Side | flow field | channels | hydrogen | |
| Features | restriction | | oxidation | |
| | | | catalyst loading | |
| | | Intruded diffusion | Higher oxygen | Higher IrOx |
| | | media | evolution | |
| | | | catalyst loading | |
| | | Inclusion of flow | Corrosion | Graphitized carbon |
| | | restricting structures | resistant | Carbon |
| | | into flow field | support | nanofiber/nanotube |
| | | | | Metal oxide support |
| | | | | such as TiOx, SnOx, |
| | | | | and/or the above oxides |
| | | | | doped with W, In, Sb, |
| | | | | and/or the like. |
| | | | No catalyst | Platinum black and/or |
| | | | support | nanostructured thin film |
| | | | | electro-catalysts |
| | | | | (“NSTF”) |
| Cathode | Lower cathode | Deeper flow field | Higher oxygen | Higher Pt loading |
| Side | flow field | channels | reduction | |
| Features | restriction | | catalyst loading | |
| | | Less intruded | Corrosion | Graphitized carbon |
| | | diffusion media | resistant | Carbon |
| | | | support | nanofiber/nanotube |
| | | | | Metal oxide support |
| | | | | such as TiOx, SnOx, |
| | | | | and/or the above oxides |
| | | | | doped with W, In, Sb, |
| | | | | and/or the like. |
| | Lower | | No catalyst | Platinum black and/or |
| | ionomer-to- | | support | NSTFs |
| | carbon ratio | | | |
| | Thicker | | | |
| | membrane | | | |

In certain embodiments, cathode end cells consistent with embodiments disclosed herein may be enhanced with features that improve their robustness relative to other cells in the stack, thus ensuring that the end cells may sustain their diagnostic capability over the life of the stack. For example, to improve end cell robustness, a higher flow in cathode end cells may be combined with a cathode-catalyst layer 104 that exhibits higher platinum loading, comprises graphitized carbon, and/or comprises a less-corrodible catalyst such as platinum black. In further embodiments, the PEM 106 may be more chemically and mechanically robust than conventional membranes.

FC stack end cells 100 consistent with embodiments disclosed herein may allow for voltage and/or resistance monitoring of the end cells and reducing and/or reduction or elimination of voltage and/or resistance monitoring requirements of the other stack cells. The end cells 100 may further incorporate diagnostic sensors, devices, and/or tools such as, for example, electrochemical hydrogen sensors, impedance measurement of end cells, and/or the like to enhance diagnostic and/or detection capabilities. In certain embodiments, a FC stack may comprise either a single end cell 100 and/or a plurality of end cells 100 consistent with embodiments disclosed herein at either or both FC stack ends. For example, in some embodiments, a FC stack may comprise 10 end cells, five on each end of the stack incorporating embodiments of the diagnostic features disclosed herein.

In certain embodiments, FC stack end cells 100 incorporating features consistent with the disclosed embodiments may be located on one and/or both ends of a FC stack assembly. In further embodiments, FC stack end cells 100 incorporating features consistent with the disclosed embodiments may be located at any other location within the FC stack assembly including locations that are not at the ends of the FC stack assembly. Table 2, provided below, provides exemplary locations for including one or more stack end cells 100 consistent with the disclosed embodiments in a FC stack assembly and associated improved diagnostic and/or detection capabilities that may be achieved by incorporating the FC stack end cells 100 in such exemplary locations.

TABLE 2

| | | Exemplary |
|---|---|---|
| | | Location |
| | Diagnostic and/or | In FC Stack |
| | Detection Capability | Assembly |
| End Cell Incorporating | Detection of insufficient | Anode dry |
| One or More Anode Side | hydrogen flow during | end and/or |
| Diagnostic and Detection | operation | wet end |
| Features | Detection of uneven hydrogen | Anode dry |
| | front during air-air to | end |
| | hydrogen-air transition | |
| End Cell Incorporating | Detection of cathode side | Cathode dry |
| One or More Cathode Side | drying during operation | end and/or |
| Diagnostic and Detection | | wet end |
| Features | Detection of air intrusion | Cathode wet |
| | during long shut-off | end |

Embodiments of the disclosed FC stack end cells 100 may, among other things, allow for detection of adverse events and/or conditions prior to associated detrimental effects occurring in other cells in the FC stack assembly. For example, in some embodiments, with a lower relative flow rate in the anode side of the FC stack end cells 100, the end cells may experience low flow stoichiometry relative to the stack current, and/or flooding conditions prior to other cells in the FC stack assembly. Accordingly, when such conditions are detected by a control system and/or sensors associated with the FC stack assembly in the FC stack end cells 100, one or more protective actions may be implemented to mitigate damage to the other cells in the FC stack assembly. In some embodiments, the anode 102 of the FC stack end cells 100 may be more tolerant to cell reversal during detection of global hydrogen starvation in the FC stack assembly due to increased oxygen evolution reaction catalyst loading and, accordingly, the end cells 100 may maintain power generation capability during normal operation.

Similarly, in certain embodiments, with a higher flow rate in the cathode side of the FC stack end cells 100, the end cells may experience unusually high flow stoichiometry, and thus increased dry-out conditions prior to other cells in the FC stack assembly, especially when the FC stack operates at high temperature and low relative humidity. Significant dry-out of a cell in the FC stack can lead to increased local heat generation and eventually to shorting and hole formation in membrane if not detected. With end cells being able to respond to the dry-out condition prior to its detrimental effects occurring in other cells in the FC stack assembly, such conditions can be detected by a control system and/or sensors associated with the FC stack assembly in the FC stack end cells 100, and one or more protective actions may be implemented to mitigate damage to the cells in the FC stack assembly.

Since the end cell 100 may have higher flow on an air side it may dry out faster than the rest of the stack. As the membrane in the end cell drys out, its protonic resistance (R) may increase at a faster rate than the rest of the stack. Since the cell voltage reduces due to ohmic losses (for which voltage reduction is equal to I times R), the cell voltage of the end cell may fall faster than the rest of the stack. The control system may monitor this leading indicator of dry-out and take necessary remedial and/or protective actions.

Among other conditions, the FC stack end cells 100 consistent with embodiments disclosed herein may be utilized in connection with detecting low flow/low stoichiometry and/or flooding conditions during extended low power or startup, low relative humidity and/or high temperature conditions, hydrogen shortage conditions during air-air start, and/or air intrusion after extended shutdown. Upon detecting such conditions, appropriate protective actions such as increasing anode stoichiometry/flow, reducing the stack temperature and/or increasing cathode inlet RH, or shutting down the FC system may be taken to mitigate damage to the FC stack assembly.

At low power, end cells 100 may detect flooding and possible remedial and/or protective actions may comprise increasing hydrogen flow rate and increasing power for a relatively short duration and/or by triggering an anode hydrogen bleed event. Increasing power may be possible if the system has capacity to sink this extra power (e.g., to charge the battery). At high power, the end cells 100 may detect excessive dryout and associated protective actions may include power reduction or temperature reduction if possible (e.g., via increasing radiator flow and/or by enabling a radiator fan).

As discussed above, a plurality of end cells incorporating diagnostic and/or robustness features consistent with the disclosed embodiments may be included in a FC stack assembly. In certain embodiments, each end cell of the plurality of end cells may incorporate one or more different features to improve diagnosis of a particular stack condition. For example, a first end cell may comprise a restricted anode flow field and a second end cell may comprise a less-restrictive cathode flow field. In this example, if the voltage of the first end cell is measured as low, hydrogen flow to the anode may be increased. Similarly, if the voltage of the second end cell is measured as low, one or more actions may be engaged to decrease stack dry out. In other embodiments, end cells may incorporate similar features consistent with the disclosed embodiments (e.g., both anode and/or cathode features), and a variety of stack conditions may be identified based on measurements of the end cells and/or terminal measurements associated with the entire FC stack assembly.

It will be appreciated that a number of variations can be made to the embodiments of the disclosed FC stack end cell 100 presented in connection with FIG. 1 within the scope of the inventive body of work. For example, FC stack end cells 100 consistent with embodiments disclosed herein may be integrated into FC stacks assemblies having a variety of other geometries and/or configurations. Thus it will be appreciated that FIG. 1 is provided for purposes of illustration and explanation and not limitation.

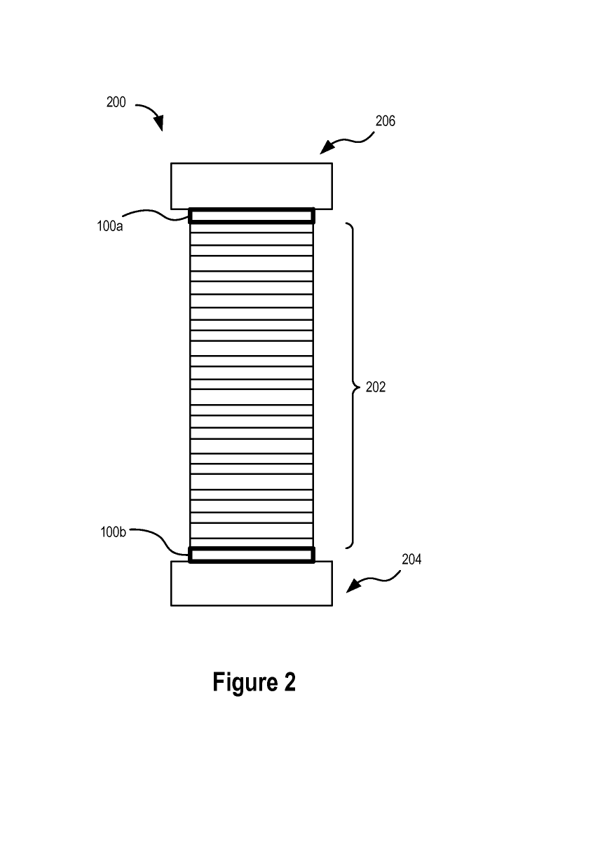

FIG. 2 illustrates a diagram of a FC stack assembly 200 including FC stack end cells 100a, 100b consistent with embodiments disclosed herein. The FC stack assembly 200 may further comprise a wet end 204 through which anode and cathode gases may enter the stack and a dry end 206. It is noted that anode and cathode gas inlets and outlets and coolant inlets and outlets are not shown in connection with the FC stack assembly 200. In certain embodiments, the FC stack end cells 100a, 100b may be configured to include certain features of the FC stack end cells described above in reference to FIG. 1, and may be differently configured than other cells 202 included in the FC stack assembly 200. In some embodiments, FC stack end cell 100a (i.e., the FC stack end cell 100a associated with the dry end 206) may be used in connection with detecting anode flooding, cell-dry out, and/or hydrogen starvation in air-air start conditions. In further embodiments, FC stack end cell 100b (i.e., the FC stack end cell 100b associated with the wet end 204) may be used in connection with detecting anode flooding, cell dry-out, and/or air intrusion conditions. Although illustrated as being located at the ends of the FC stack assembly 200, as discussed above, in other embodiments, FC stack end cells 100a, 100b consistent with the disclosed embodiments may be located at any location within the FC stack assembly 200.

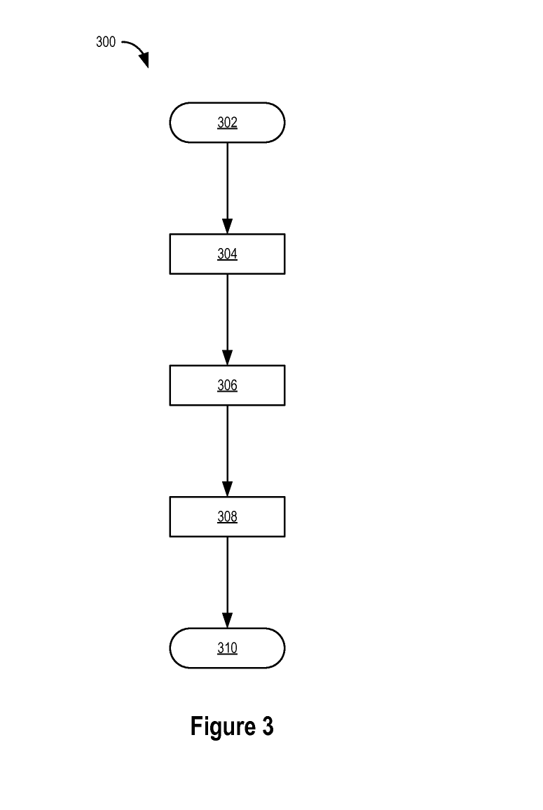

FIG. 3 illustrates a flow chart of an exemplary method 300 of assembling a FC stack consistent with embodiments disclosed herein. Particularly, method 300 may be used to assemble a FC stack assembly incorporating FC stack end cells consistent with embodiments disclosed herein. At 302, the method 300 may be initiated. At 304, a plurality of fuel cells may be assembled in a stack configuration. For example, the plurality of cells may be stacked together in electrical series and be separated by gas impermeable, electrically conductive bipolar plates.

At 306, a first end cell or set of end cells may be disposed at a first end of the stack configuration. The first end cell or set of end cells may, among other things, comprise an anode side having a lower anode gas flow relative to the other fuel cells in the stack configuration and a cathode side comprising a cathode side having a higher cathode gas flow relative to the other fuel cells in the stack configuration. A second end cell or set of end cells may be disposed at a second end of the stack configuration at 308. Like the first end cell, the second end cell or set of end cells may, among other things, comprise an anode side having a lower anode gas flow rate relative to the other fuel cells in the stack configuration and a cathode side comprising a cathode side having a higher cathode gas flow rate relative to the other fuel cells in the stack configuration. Utilizing first and second cells having the aforementioned configuration may, for example, allow for detection of adverse conditions and/or events in the FC stack assembly prior to such conditions and/or events negatively affecting other cells in the FC stack. At 310, the method 300 may end.

Although the foregoing has been described in some detail for purposes of clarity, it will be apparent that certain changes and modifications may be made without departing from the principles thereof. For example, in certain embodiments, the systems and methods disclosed herein may be utilized in connection with FC systems not included in a vehicle. It is noted that there are many alternative ways of implementing both the processes and systems described herein. Accordingly, the present embodiments are to be considered illustrative and not restrictive, and the invention is not to be limited to the details given herein, but may be modified within the scope and equivalents of the appended claims.

The foregoing specification has been described with reference to various embodiments. However, one of ordinary skill in the art will appreciate that various modifications and changes can be made without departing from the scope of the present disclosure. For example, various operational steps, as well as components for carrying out operational steps, may be implemented in alternate ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element.

As used herein, the terms “comprises” and “includes,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection. Those having skill in the art will appreciate that many changes may be made to the details of the above-described embodiments without departing from the underlying principles of the invention. The scope of the present invention should, therefore, be determined only by the following claims.

1. A fuel cell system included in a vehicle comprising:
a plurality of fuel cells configured in a fuel cell stack assembly, wherein the plurality of fuel cells comprise:
at least one end cell disposed on a first end of the fuel cell stack, the at least one cell comprising an anode side configured to exhibit a lower anode gas flow rate relative to other fuel cells of the plurality of fuel cells in the fuel cell stack assembly,
wherein an anode material of the anode side comprises an anode material having a higher amount of oxygen evolution reaction catalyst relative to anodes included in the other fuel cells of the plurality of fuel cells.

2. The fuel cell system of claim 1, wherein the lower anode gas flow rate comprises at least a 5% lower flow rate.

3. The fuel cell system of claim 1, wherein the anode side of the at least one end cell comprises a plurality of anode side flow channels that are more shallow relative to anode side flow channels included in the other fuel cells of the plurality of fuel cells.

4. The fuel cell system of claim 1, wherein the anode side of the at least one end cell comprises a gas diffusion layer configured to intrude into anode side flow channels of the anode side more than diffusion media layers associated with the other fuel cells of the plurality of fuel cells.

5. The fuel cell system of claim 1, wherein the anode side of the at least one end cell comprises an anode flow field that comprises at least one flow restricting structure.

6. The fuel cell system of claim 1, wherein the oxygen evolution reaction catalyst comprises iridium oxide.

7. The fuel cell system of claim 1, wherein the anode material comprises a corrosion resistant material.

8. The fuel cell system of claim 7, wherein the corrosion resistant material comprises at least one of graphitized carbon, carbon nanotubes, carbon nanofibers, and a metal oxide material.

9. The fuel cell system of claim 1, wherein the anode material comprises platinum black.

10. The fuel cell system of claim 1, wherein the at least one end cell comprises an end cell of a plurality of end cells included in the fuel cell stack assembly, each end cell of the plurality of end cells having a side configured to exhibit a different reactant gas flow rate relative to the other fuel cells of the plurality of fuel cells.

11. A fuel cell system included in a vehicle comprising:
a plurality of fuel cells configured in a fuel cell stack assembly, wherein the plurality of fuel cells comprise:
at least one end cell disposed on a first end of the fuel cell stack, the at least one cell comprising an cathode side configured to exhibit a higher cathode gas flow rate relative to other fuel cells of the plurality of fuel cells in the fuel cell stack assembly,
wherein a cathode material of the cathode side comprises a cathode material having a lower ionmeter-to-carbon ratio relative to cathodes included in the other fuel cells of the plurality of fuel cells.

12. The fuel cell system of claim 11, wherein the higher cathode gas flow rate comprises at least a 5% higher flow rate.

13. The fuel cell system of claim 11, wherein the cathode side of the at least one end cell comprises a plurality of cathode side flow channels that are deeper relative to cathode side flow channels included in the other fuel cells of the plurality of fuel cells.

14. The fuel cell system of claim 11, wherein the cathode side of the at least one end cell comprises a gas diffusion layer configured to intrude into cathode side flow channels of the cathode side less than diffusion media layers associated with the other fuel cells of the plurality of fuel cells.

15. The fuel cell system of claim 11, wherein the cathode material of the cathode side of the at least one end cell comprises a material having higher platinum loading relative to cathodes included in the other fuel cells of the plurality of fuel cells.

16. The fuel cell system of claim 11, wherein the cathode material comprises a corrosion resistant material.

17. The fuel cell system of claim 16, wherein the corrosion resistant material comprises at least one of graphitized carbon, carbon nanotubes, carbon nanofibers, and a metal oxide material.

18. The fuel cell system of claim 11, wherein the cathode material comprises platinum black.

19. The fuel cell system of claim 11, wherein the at least one end cell comprises an end cell of a plurality of end cells included in the fuel cell stack assembly, each end cell of the plurality of end cells having a side configured to exhibit a different reactant gas flow rate relative to the other fuel cells of the plurality of fuel cells.

20. A method for assembling a fuel cell system comprising:
assembling components of a fuel cell stack of the fuel cell system, wherein the assembling comprises:
disposing a plurality of fuel cells in a stack configuration;
disposing a first end cell at a first end of the stack configuration; and
disposing a second end cell at a second end of the stack configuration,
wherein the first end cell and the second end cell each comprise an anode side having a lower anode gas flow rate relative to the plurality of fuel cells of the fuel cell stack assembly, and
wherein the first end cell and the second end cell each comprise a cathode side having a higher cathode gas flow rate relative to the plurality of fuel cells of the fuel cell stack assembly.
